(19) United States
(12) Patent Application Publication
(10) Pub. No.: US 2008/0023630 A1
(43) Pub. Date: Jan. 31, 2008

(54) POLYMER PROBE DOPED WITH CONDUCTIVE MATERIAL FOR MASS SPECTROMETRY

(75) Inventors: Egisto Boschetti, Croissy sur Seine (FR); Lee O. Lomas, Pleasanton, CA (US)

Correspondence Address: MORGAN, LEWIS & BOCKIUS LLP (SF), 2 PALO ALTO SQUARE, 3000 El Camino Real, Suite 700, PALO ALTO, CA, 94306, US

(73) Assignee: CIPHERGEN BIOSYSTEMS INC.

(21) Appl. No.: 11/557,286

(22) Filed: Nov. 7, 2006

Related U.S. Application Data
(60) Provisional application No. 60/738,575, filed on Nov. 22, 2005.

(51) Int. Cl. H01J 49/00

(52) U.S. Cl. 250/282; 250/288

(57) ABSTRACT

A mass spectrometer probe is formed of a nonconductive polymer that is doped with conductive material. The probe may be used as, or as part of, a repeller plate in a parallel laser ion desorption/ionization time-of-flight mass spectrometer. Transparent locations on the probe enable a sample placed thereon to be visualized before or during mass spectrometry. The conductive nature of the probe maintains the consistency of the electromagnetic field applied to the sample. The probe also displays low outgassing and high mechanical and chemical stability, thereby enabling it to be used repetitively.

### BACKGROUND OF THE INVENTION

Laser desorption/ionization mass spectrometers (“LDI-MS”) configured for parallel extraction typically use probes (also called “targets”) comprising metal. Metal has been used in probes because it is believed that such probes cause less distortion of the electric field in which ions are created during the laser desorption/ionization process. However, probes comprising non-metallic and other conductive materials also have been described. See, e.g., U.S. Pat. No. 5,719,060 (Hutchens and Yip), and U.S. Pat. No. 6,225,047 (Hutchens and Yip).

The surface of a probe on which a sample is placed and presented to ionizing energy is frequently referred to as a “sample presenting surface.” Certain versions of LDI-MS employ probes whose sample presenting surfaces have been modified to interact with a sample in various desirable ways. For example, U.S. Pat. No. 6,287,872 (Schurenberg et al.) describes an electrically conductive support plate in which hydrophobic areas surround hydrophilic areas to create a so-called “anchor” site for a sample. U.S. Patent Application Publication No. 2005-0164402 A1 (Belisle et al.) describes a sample presenting device comprising a plurality of zones of different wettability. U.S. Pat. No. 5,955,729 (Nelson et al.) describes a biochip for surface plasmon resonance also used in mass spectrometry. Certain patent documents describe probes onto which a polymer has been attached, either through physisorption or chemisorption. U.S. Pat. No. 6,225,047 (Hutchens and Yip) describes biochips with a variety of different adsorbent (analyte binding) surfaces. Certain of these involve covalently attaching the polymer to chemical groups on the sample presenting surface. See, e.g., U.S. Pat. No. 6,897,072 (Rich et al.), U.S. Patent Application Publication Nos. 2003/0017464 A1 (Pohl), 2003/0207460 A1 (Kitagawa), 2003/0124371 A1 (Um et al.), 2003/0218130 A1 (Boschetti et al.), and 2005/0059086 A1 (Huang et al.), and International Patent Application No. WO 04/076511 (Huang et al.).

Typically, mass spectrometry is extremely useful when analyzing a particular analyte (e.g., protein or peptide) when the analyte is not masked by other molecules in the sample. For such analysis, there are many commercially available gas phase ion spectrometers (e.g., vendors include Ciphergen Biosystems, Inc., Waters, Micromass, MDS, Shimadzu, Applied Biosystems and Bruker Biosciences).

As shown in FIG. 10, a typical mass spectrometer 1000 that employs parallel ion source time-of-flight (“TOF”) includes: (a) a repeller plate 1010; (b) an extractor plate 1040; (c) a ground plate 1020 that includes an aperture 1022; (d) an ion detector 1030; (e) a laser 1050 that is configured to emit light; (f) a mirror 1060 that is configured to reflect the light emitted by the laser 1050 toward the repeller plate 1010, which impacts sample-matrix co-crystals located on a sample probe within the repeller plate 1010 to initiate a sample ionization event. The sample ions drift into an ion acceleration region 1015, which is defined between the repeller and ground plates 1010, 1020. Similarly, an ion-drift region 1025 is defined between the ground plate 1020 and the ion detector 1030, usually within an ion deflector 1070. The mass spectrometer probe on which the analytes are placed essentially becomes part of the portion of the repeller plate 1010 that receives laser light from the mirror 1060 to initiate the sample ionization event. The repeller plate 1010 is conductive so as to generate a substantially uniform electromagnetic field between the repeller and ground plates 1010, 1020.

In an ion laser desorption/ionization TOF mass spectrometer, sample particles are accelerated to the same level of kinetic energy. As a result, heavier ion particles will be accelerated to a slower velocity as compared to lighter ion particles, as shown in the following equation:

v=sqrt(2eV/m)

where v is the final velocity, e is the ion charge, V is the acceleration voltage, and m is the ion mass. By altering the uniformity of the electromagnetic field, a nonconductive probe causes non-uniformity in the achieved kinetic energy of the ions and, therefore, impacts the calculated velocity of the desorbed ions. As a result, if the achieved kinetic energy of a portion of a similar population of ions is decreased, the resultant velocity of that portion of ions will be correspondingly decreased, and the calculated mass/charge ratio of those ions will be overestimated. Similarly, if the achieved kinetic energy of a portion of a similar population of ions is increased, the resultant velocity of that portion of ions will be correspondingly increased, and the calculated mass/charge ratio of those ions will be underestimated. Accordingly, without a generally uniform electromagnetic field between the repeller and ground plates 1010, 1020, the resultant output of the mass spectrometer can have shifted and less resolved peaks.

To prevent such unpredictable skewing of the mass spectrometry results, probes (which essentially become part of the repeller plate) are typically formed of metal, which is conductive. As a result, the conductive nature of the probe enables the probe to avoid negatively impacting (e.g., disrupting) the electromagnetic field between the repeller and ground plates 1010, 1020, i.e., the conductive nature of the probe ensures that the electromagnetic field remains generally uniform.

What is needed, therefore, is an apparatus and a methodology that address at least one if not more of the deficiencies that afflict conventional practice, as previously described.

### SUMMARY OF THE INVENTION

An embodiment of the present invention addresses a method of sample analysis that includes, among other possible steps: applying a sample comprising an analyte to a sample presenting surface of a mass spectrometer probe, wherein the mass spectrometer probe comprises a polymer doped with a conductive material; engaging the probe with a probe interface of a mass spectrometer that generates ions through a desorption/ionization process, wherein the mass spectrometer is configured for parallel ion extraction; desorbing and ionizing the analyte from the sample presenting surface with energy from an energy source; and detecting the desorbed and ionized analyte.

In a further embodiment of this method, the polymer may be selected from the group consisting of polymethylpentene, polybutyltherephtalate, and polyacrylates.

In another further embodiment of this method, the conductive material may be selected from the group consisting of graphite, metal, and metal oxide.

In another further embodiment of this method, the polymer may comprise polymethylpentene and the conductive material may be graphite.

In another further embodiment of this method, the probe may further comprise analyte binding moieties bonded to the sample presenting surface through photo-activated chemistry.

In another further embodiment of this method, the energy source may be a laser.

In another further embodiment of this method, the sample presenting surface may have one or more locations onto which the analyte may be positioned for analysis. Further, the one or more locations may be transparent to visible light.

In another further embodiment of this method, the probe may be made by two or more layers of plastic with at least one different predetermined property selected from the group consisting of transparency, porosity, hydrophobicity, and ability to react with a hydrophilic polymer through photo-activated chemistry.

In another further embodiment of this method, the probe may comprise at least one microstructure.

In another further embodiment of this method, the probe may further comprise a hydrogel attached to the sample presenting surface through a photo-activated chemistry.

In another further embodiment of this method, the conductive material may be non-metallic. Further, the probe may be substantially free of metal. Moreover, the non-metallic conductive material may be selected from the group consisting of graphite, antimony-tin oxide, and indium-tin oxide.

In another further embodiment of this method, the probe may be substantially rectangular in shape.

In another further embodiment of this method, the probe may be substantially tubular in shape.

In another further embodiment of this method, the probe may be substantially disk-shaped.

Another embodiment of the present invention addresses a mass spectrometer probe that includes, among other possible things, a substrate that comprises a polymer doped with a conductive material. The probe comprises an engagement mechanism that is configured to engage a probe interface of a mass spectrometer that generates ions through a desorption/ionization process. The mass spectrometer is configured for parallel ion extraction.

In a further embodiment of this mass spectrometer probe, the polymer may be selected from the group consisting of polymethylpentene, polybutyltherephtalate, and polyacrylates.

In another further embodiment of this mass spectrometer probe, the conductive material may be selected from the group consisting of graphite, metal, and metal oxide.

In another further embodiment of this mass spectrometer probe, the polymer may comprise polymethylpentene and the conductive material may be graphite.

In another further embodiment of this mass spectrometer probe, the probe may further comprise analyte binding moieties bonded to a sample presenting surface through photo-activated chemistry.

In another further embodiment of this mass spectrometer probe, the sample presenting surface may have one or more locations that are configured to receive an analyte for analysis. Further, the one or more locations may be transparent to visible light.

In another further embodiment of this mass spectrometer probe, the probe may be made by two or more layers of plastic with at least one different predetermined property selected from the group consisting of transparency, porosity, hydrophobicity, and ability to react with a hydrophilic polymer through photo-activated chemistry.

In another further embodiment of this mass spectrometer probe, the probe may comprise at least one microstructure.

In another further embodiment of this mass spectrometer probe, the probe may comprise a hydrogel attached to the sample presenting surface through a photo-activated chemistry.

In another further embodiment of this mass spectrometer probe, the conductive material may be non-metallic. Further, the probe may be substantially free of metal. Moreover, the non-metallic conductive material may be selected from the group consisting of graphite, antimony-tin oxide, and indium-tin oxide.

In another further embodiment of this mass spectrometer probe, the probe may be substantially rectangular in shape.

In another further embodiment of this mass spectrometer probe, the probe may be substantially tubular in shape.

In another further embodiment of this mass spectrometer probe, the probe may be substantially disk-shaped.

Another embodiment of the present invention addresses a time-of-flight mass spectrometer that includes, among other possible things: (a) an ion source that includes, among other possible things: (i) a probe interface and a probe engaged therewith, wherein the probe includes, among other possible things: (A) a polymer that is doped with a conductive material; and (B) a sample presenting surface; (ii) an energy source; and (iii) an ion optic assembly; (b) a mass analyzer comprising a sub-assembly defining a free flight path; and (c) an ion detector. The ion optic assembly is configured to deliver desorbed/ionized analyte molecules in a parallel extraction configuration to the mass analyzer. The ion detector is configured to detect ions passing through the free flight path.

In a further embodiment of this mass spectrometer, the polymer may be selected from the group consisting of polymethylpentene, polybutyltherephtalate, and polyacrylates.

In another further embodiment of this mass spectrometer, the conductive material may be selected from the group consisting of graphite, metal, and metal oxide.

In another further embodiment of this mass spectrometer, the sub-assembly may comprise a flight tube or an electric sector.

In another further embodiment of this mass spectrometer, the energy source may be a laser.

In another further embodiment of this mass spectrometer, the probe may comprise a hydrogel attached to the sample presenting surface through a photo-activated chemistry.

In another further embodiment of this mass spectrometer, the polymer may comprise polymethylpentene and the conductive material may be graphite.

In another further embodiment of this mass spectrometer, the probe may further comprise analyte binding moieties bonded to the sample presenting surface through photo-activated chemistry.

In another further embodiment of this mass spectrometer, the sample presenting surface may have one or more locations that are configured to receive an analyte for analysis. Further, the one or more locations may be transparent to visible light.

In another further embodiment of this mass spectrometer, the probe may be made by two or more layers of plastic with at least one different predetermined property selected from the group consisting of transparency, porosity, hydrophobicity, and ability to react with a hydrophilic polymer through photo-activated chemistry.

In another further embodiment of this mass spectrometer, the probe may comprise at least one microstructure.

In another further embodiment of this mass spectrometer, the conductive material may be non-metallic. Further, the probe may be substantially free of metal. Moreover, the non-metallic conductive material may be selected from the group consisting of graphite, antimony-tin oxide, and indium-tin oxide.

In another further embodiment of this mass spectrometer, the probe may be substantially rectangular in shape.

In another further embodiment of this mass spectrometer, the probe may be substantially tubular in shape.

In another further embodiment of this mass spectrometer, the probe may be substantially disk-shaped.

Another embodiment of the present invention addresses a method of forming a mass spectrometer probe that is configured to engage a probe interface of a mass spectrometer, which generates ions through a desorption/ionization process and which is configured for parallel ion extraction. The method includes, among other possible steps: doping a nonconductive first polymer with a conductive material; molding the doped first polymer into a probe that is configured to engage a probe interface of a mass spectrometer; coating a surface of the probe with a second polymer comprising at least one photoreactive moiety; covering the coated surface with a mask that exposes one or more areas on the surface; treating the exposed areas such that the photoreactive moieties of the second polymer in the exposed areas bind to the surface of the probe, thereby forming a hydrogel; removing the mask; and removing the second polymer from the unexposed areas of the surface.

In a further embodiment of this method, the first polymer may be selected from the group consisting of polymethylpentene, polybutyltherephtalate, and polyacrylates.

In another further embodiment of this method, the conductive material may be selected from the group consisting of graphite, metal, and metal oxide.

In another further embodiment of this method, the step of treating may comprise irradiating the exposed areas with ultraviolet light.

In another further embodiment of this method, the coating step may further comprise coating the surface with a third polymer that includes, among other possible things, analyte binding moieties. Further, the photoreactive moieties may further bind the second polymer to the third polymer in the treating step.

In another further embodiment of this method, the second polymer may be a co-polymer that includes, among other possible things: monomers that include, among other possible things, the photoreactive moiety; and monomers that include, among other possible things, analyte binding moieties.

In another further embodiment of this method, the method may further include the step of: forming a microstruture around at least one of the area(s) of the sample presenting surface.

In another further embodiment of this method, the conductive material may be non-metallic. Further, the probe may be substantially free of metal. Moreover, the non-metallic conductive material may be selected from the group consisting of graphite, antimony-tin oxide, and indium-tin oxide.

These and other features, aspects, and advantages of the present invention will become more apparent from the following description, appended claims, and accompanying exemplary embodiments shown in the drawings.

### BRIEF DESCRIPTION OF THE DRAWINGS

FIG. 1 is a perspective view of a first embodiment of a mass spectrometer probe according to the present invention, the probe being generally rectangular in shape;

FIG. 2A is a perspective view of a repeller plate of a constant energy ion laser desorption/ionization TOF mass spectrometer, the plate being configured to engage the rectangular probe of FIG. 1;

FIG. 2B is a perspective view of a carrier plate of a constant energy ion laser desorption/ionization TOF mass spectrometer, the carrier plate being configured to engage the rectangular probe of FIG. 1 and a repeller plate of a constant energy ion laser desorption/ionization TOF mass spectrometer;

FIG. 3 is a perspective view of a second embodiment of a mass spectrometer probe according to the present invention, the probe being generally tubular in shape;

FIG. 4A is a perspective view of a repeller plate of a constant energy ion laser desorption/ionization TOF mass spectrometer, the plate being configured to engage the tubular probe of FIG. 3;

FIG. 4B is a perspective view of a carrier plate of a constant energy ion laser desorption/ionization TOF mass spectrometer, the carrier plate being configured to engage the tubular probe of FIG. 3 and a repeller plate of a constant energy ion laser desorption/ionization TOF mass spectrometer;

FIG. 5 is a perspective view of a third embodiment of a mass spectrometer probe according to the present invention, the probe being generally disk-shaped;

FIG. 6A is a perspective view of a repeller plate of a constant energy ion laser desorption/ionization TOF mass spectrometer, the plate being configured to engage the disk-shaped probe of FIG. 5;

FIG. 6B is a perspective view of a carrier plate of a constant energy ion laser desorption/ionization TOF mass spectrometer, the carrier plate being configured to engage the disk-shaped probe of FIG. 5 and a repeller plate of a constant energy ion laser desorption/ionization TOF mass spectrometer;

FIG. 7A is a mass spectrometry output of a peptide presented in a mass spectrometer on a nonconductive polybutyltherephtalate probe;

FIG. 7B is a mass spectrometry output of the peptide of FIG. 7A presented in the mass spectrometer on a conductive, carbon black doped polybutyltherephtalate probe;

FIG. 7C shows mass spectrometry results of human serum at pH 4 and pH 9 on the carbon black doped polybutyltherephtalate probe of FIG. 7B; and

FIG. 7D shows mass spectrometry results of the human serum of FIG. 7C at pH 4 and pH 9 on a standard Q10 ProteinChip® array probe;

FIG. 8 is a chemical diagram of a blended copolymer formed of benzophenone derivitized dextran and a binding moiety group derivatized dextran;

FIG. 9 is a block-diagram of a method of forming a probe from a polymer doped with conductive material; and

FIG. 10 is a schematic view of a conventional constant energy ion laser desorption/ionization TOF mass spectrometer.

### DETAILED DESCRIPTION OF THE PREFERRED EMBODIMENTS

“Gas phase ion spectrometer” refers to an apparatus that detects gas phase ions. Gas phase ion spectrometers include an ion source that supplies gas phase ions. As a result, gas phase ion spectrometers include, e.g., mass spectrometers, ion mobility spectrometers, and total ion current measuring devices. “Gas phase ion spectrometry” refers to the use of a gas phase ion spectrometer to detect gas phase ions.

“Mass spectrometer” refers to a gas phase ion spectrometer that measures a parameter that can be translated into mass-to-charge ratios of gas phase ions. Examples of mass spectrometers include: (a) constant-energy gas phase ion laser desorption/ionization TOF mass spectrometers; (b) magnetic sector mass spectrometers; (c) quadrupole filter mass spectrometers; (d) ion trap mass spectrometers; (e) ion cyclotron resonance mass spectrometers; (f) electrostatic sector analyzer mass spectrometers; and (g) hybrids of these. “Mass spectrometry” refers to the process of using a mass spectrometer to detect gas phase ions. Mass spectrometers generally include an ion source, a mass analyzer and a detector.

“Ion source” refers to a sub-assembly of a gas phase ion spectrometer (or mass spectrometer) that provides gas phase ions to the mass analyzer. In one embodiment, the ion source provides ions through a desorption/ionization process. Such embodiments generally comprise a probe interface that positionally engages a probe and aligns the probe with: (a) a source of ionizing energy (e.g., a laser desorption/ionization source) at atmospheric or subatmospheric pressure; and (b) a detector of gas phase ions. Forms of ionizing energy for desorbing/ionizing an analyte from a solid phase include, for example: (1) laser energy; (2) fast atoms (used in fast atom bombardment); (3) high energy particles generated via beta decay of radionucleides (used in plasma desorption); and (4) primary ions generating secondary ions (used in secondary ion mass spectrometry).

The preferred form of ionizing energy for solid phase analytes is a laser (used in laser desorption/ionization), in particular, nitrogen lasers, Nd-Yag lasers and other pulsed laser sources. “Fluence” refers to the energy delivered per unit area of interrogated image. A high fluence source, such as a laser, will deliver about 1 to about 50 mJ per mm². Typically, a sample is placed on the surface of a probe, the probe is engaged with the probe interface and the probe surface is struck with the ionizing energy from the laser. The energy desorbs analyte molecules from the surface into the gas phase and ionizes them. “Laser desorption mass spectrometer” refers to a mass spectrometer that uses laser energy as a means to desorb, volatilize, and ionize an analyte.

Examples of other forms of ionizing energy for analytes include: (1) electrons that ionize gas phase neutrals; (2) a strong electric field that induces ionization from gas phase, solid phase, or liquid phase neutrals; and (3) a source that applies a combination of ionization particles or electric fields with neutral chemicals to induce chemical ionization of solid phase, gas phase, and liquid phase neutrals.

Mass spectrometers frequently include ion optics to direct the flight of ions. In a parallel extraction TOF instrument, ion optics are included as part of the ion source. More particularly, as shown in FIG. 10, the optics typically include a repeller plate 1010, an extractor plate 1040 and a ground plate 1020. A voltage applied between these electrodes propels ions into the flight tube.

“Mass analyzer” refers to a sub-assembly of a mass spectrometer that comprises means for measuring a parameter that can be translated into mass-to-charge ratios of gas phase ions. In a TOF mass spectrometer the mass analyzer comprises a free flight path. For example, in a linear TOF instrument, the mass analyzer comprises a flight tube. In instruments comprising electric sectors (e.g., U.S. Pat. No. 6,867,414), the mass analyzer includes electric sectors and field free regions.

The ion detector, in a linear TOF instrument is located at the end of the flight tube. The ion detector can include an electron multiplier or a microchannel plate.

As later described in detail, this invention provides conductive mass spectrometer probes that are formed of a polymer doped with a conductive material. “Probe” refers to a device adapted to engage a probe interface of a gas phase ion spectrometer (hereinafter “mass spectrometer”) and to present an analyte sample to ionizing energy for ionization by introduction into a mass spectrometer. Moreover, the probes may be used in mass spectrometry analysis for purposes of research, diagnosis, prediction of purification processes, protein identification, assay, etc. Further, in certain embodiments the probes may be used in a combination of non-mass spectrometry device (e.g., light microscopy, fluorescence, chemiluminescence, etc.) and a mass spectrometry device both of which would be used to analyze a sample on the sample presenting surface. Moreover, with respect to the mass spectrometry device, the probes may be used as, or as part of, a repeller plate in parallel laser ion desorption/ionization TOF mass spectrometers.

As hereafter explained, the invention not only relates to a probe that is mechanically structured for engagement with a corresponding apparatus in a mass spectrometer, but also to the type of materials from which the probe may be manufactured, the type of materials that may be applied to the probe to facilitate maintaining a sample thereon, the method by which the probe is manufactured, and a method of mass spectrometry using such a probe.

### Mass Spectrometer Probe

Typically, a probe will comprise a solid substrate that includes a sample presenting surface on which an analyte is presented to the source of ionizing energy. Particular target properties for the probe according to the present invention include: (a) optional optical transparency of at least portions of the probe; (b) electrical conductivity; (c) low outgassing; (d) presence of abstractable hydrogen atoms on the surface of the probe's polymeric substrate for reacting with photoreactive chemistries such as benzophenone; (e) good sample retention characteristics for direct application of a sample onto the probe or onto a binding group layered on the probe; (f) hydrophobicity; (g) moldability; (h) mechanical stability; and (i) chemical stability in the presence of, and compatibility with, solvents used for sample application.

As a result of the conductive doping material in the polymer, the probe maintains the consistency of the electromagnetic field applied to the sample in a mass spectrometer. The probe also displays low outgassing and high chemical stability, thereby enabling it to be used repetitively. A hydrophobic surface of the probe can be configured to receive a hydrophilic hydrogel. Microstructures, which may be in the form of moats formed in the sample presenting surface, and/or the surface's hydrophobicity can be used to maintain a sample on the sample presenting surface or on a hydrogel on the sample presenting surface. The microstructures, which may be on the order of about 200 μm in width and about 100 μm in depth, may be in the form of channels and/or indentation in the sample presenting surface.

In an embodiment of the present invention, the probe may be designed to serve as a chip onto which samples comprising the analyte (e.g., biomolecules such as proteins, peptides, nucleic acids, lipids, complex carbohydrates, etc.) are placed. Moreover, in some embodiments, the probe may become part of the repeller plate in a gas phase ion mass spectrometer. In other embodiments, the probe may interface with a carrier plate that, in turn, interfaces with the repeller plate of a gas phase ion mass spectrometer. To facilitate its being positioned in a sample chamber of a mass spectrometer, the probe includes an engagement mechanism that is configured to engage a complementary structure of a probe interface of either the repeller plate or the carrier plate. The term “positioned” is generally understood to mean that the probe can be moved into a position within the sample chamber in which it resides in appropriate alignment with the energy source for the duration of a particular desorption/ionization cycle.

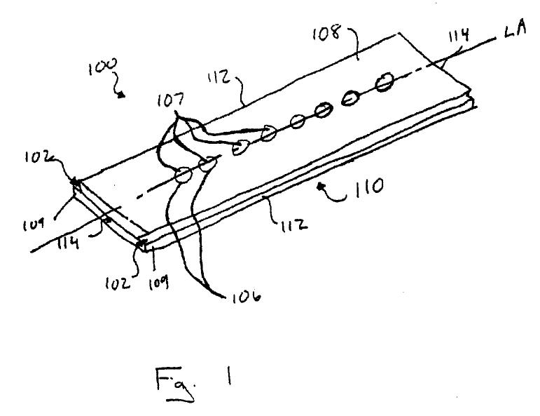

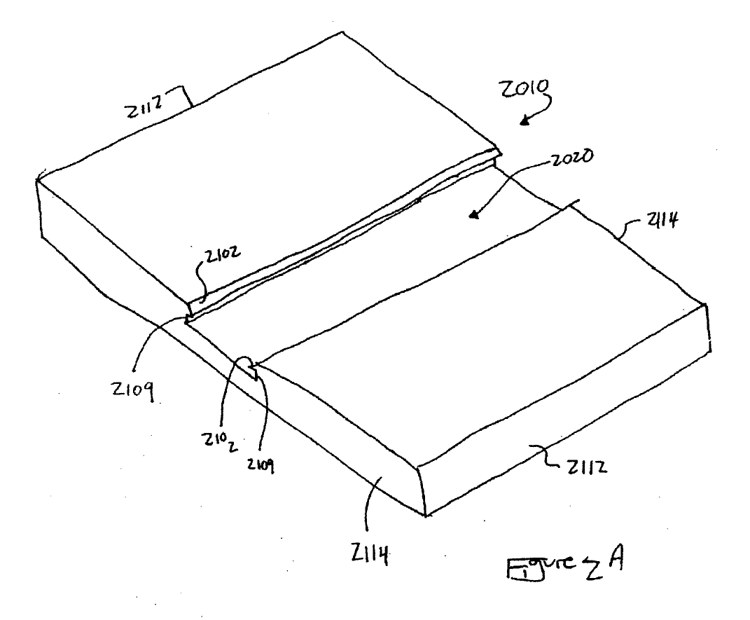

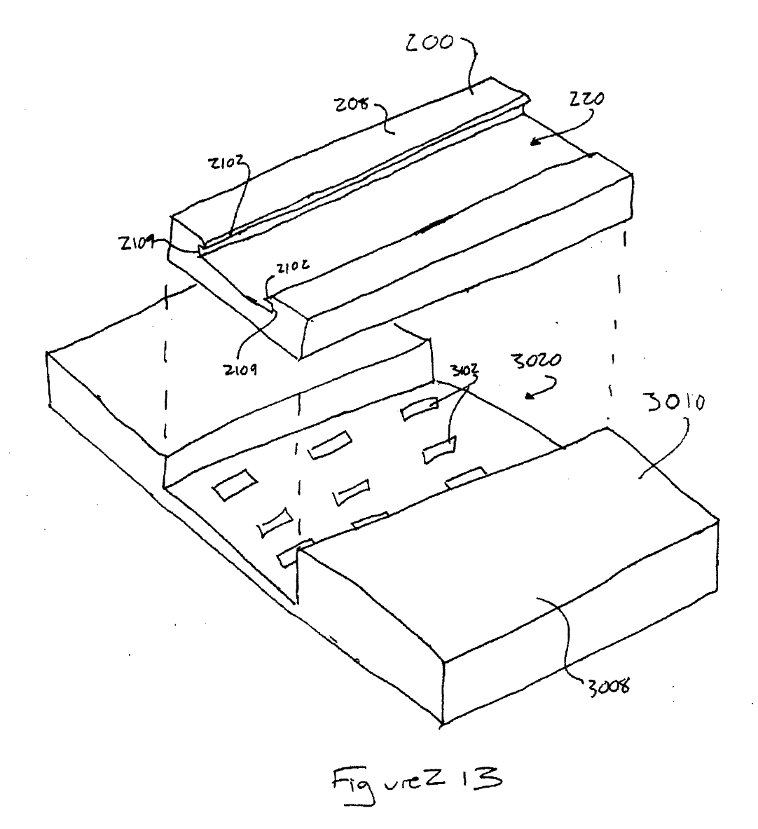

A first embodiment of a mass spectrometer probe according to the present invention will hereafter be described with reference to FIGS. 1-2B.

As shown in FIG. 1, the probe 100, which is generally rectangular in shape, includes a top, sample presenting surface 108 and an opposite underside 110. The sample presenting surface 108 provides a plurality of locations 107 onto which a mass spectrometry sample may be provided. Of course, the locations 107 may be in the form of microwells, e.g., depressions formed in the sample presenting surface 108. Moreover, one or more of the locations may be circumscribed by a microstructure 106 such as a moat, which serves to facilitate maintaining a sample at a, particular location 107. Further, the locations 107 and/or microstructures 106 may be arranged in an array of addressable locations, e.g., a Cartesian coordinate system, thereby enabling a technician to track the location of particular samples on the sample presenting surface 108.

The perimeters of the sample presenting surface 108 and the underside 110 are connected by two sidewalls 112 and two endwalls 114. Whereas the endwalls 114 are generally planar in shape, the sidewalls 112 are substantially v-shaped, thereby defining channels 102. The channels 102 are sized and configured to receive rails 2102 formed on either a repeller plate 2010 or a carrier plate 200. The sidewalls 112 also include notch projections 109 that are sized to be received in channels 2109 formed on either a repeller plate 2010 or a carrier plate 200. As a result of the engagement between the v-shaped channels 102 and the notch projections 109 of the probe 100 and the rails 2102 and the channels 2109, respectively, of the repeller plate 2010 (or the carrier plate 200), the probe 100 can be immobilized in the repeller plate 2010 (or the carrier plate 200), as hereafter discussed with respect to FIGS. 2A (repeller plate 2010) and 2B (carrier plate 200).

In a manner similar to the probe 100, the repeller plate 2010 includes a topside 2108, an underside 2110, two sidewalls 2112, and two endwalls 2114. As shown, a probe receiving section 2020 is formed in the topside 2108 of the repeller plate 2010. The probe receiving section 2020 includes two rails 2102 and two channels 2109, which jointly serve as a probe interface. The rails 2102 and channels 2109 are sized such that the probe 100 may slide into the repeller plate 2010 in a direction parallel to a longitudinal axis LA of the probe 100 (shown in FIG. 1). When the probe 100 slides into the probe receiving section 2020, the notch projections 109 will be received in the channels 2109 and the v-shaped channels 102 will receive the rails 2102. As a result, when the probe 100 is fully positioned in the probe receiving section 2020 of the repeller plate 2010, the top, sample presenting surface 108 of the probe 100 will be substantially coplanar with the topside 2108 of the repeller plate 2010.

As shown in FIG. 2B, the carrier plate 200 interacts with the probe 100 in the same manner as the repeller plate 2010. In other words, the carrier plate 200 also includes a probe receiving section 220 that is defined by two rails 2102 and two channels 2109, which jointly serve as a probe interface. Moreover, when the probe 100 is positioned in the probe receiving section 220, the top, sample presenting surface 108 of the probe and a topside 208 of the carrier plate 200 will be substantially coplanar. In turn, the carrier plate 200 is sized to be received in a carrier plate receiving section 3020 of a repeller plate 3010. When the carrier plate 200 is received in the carrier plate receiving section 3020 of the repeller plate 3010, the topside 208 of the carrier plate will not only be substantially coplanar with the top, sample presenting surface 108 of the probe 100 but also a topside 3008 of the repeller plate 3010. To maintain the carrier plate 200 in the carrier plate receiving section 3020 of the repeller plate 3010, numerous engagement means may be employed; magnets 3102 are one example of such engagement means.

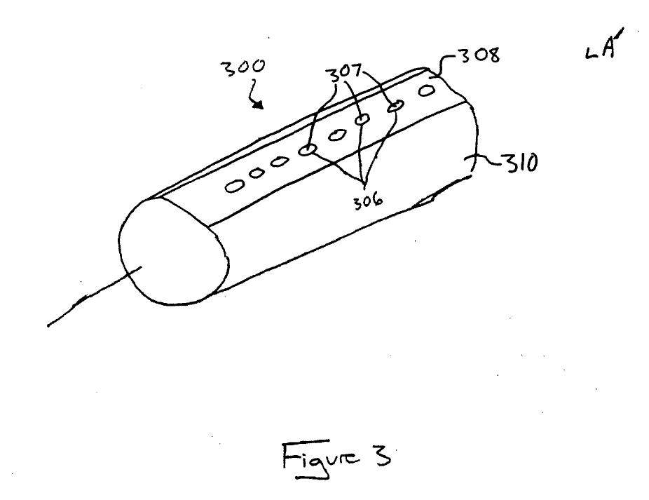

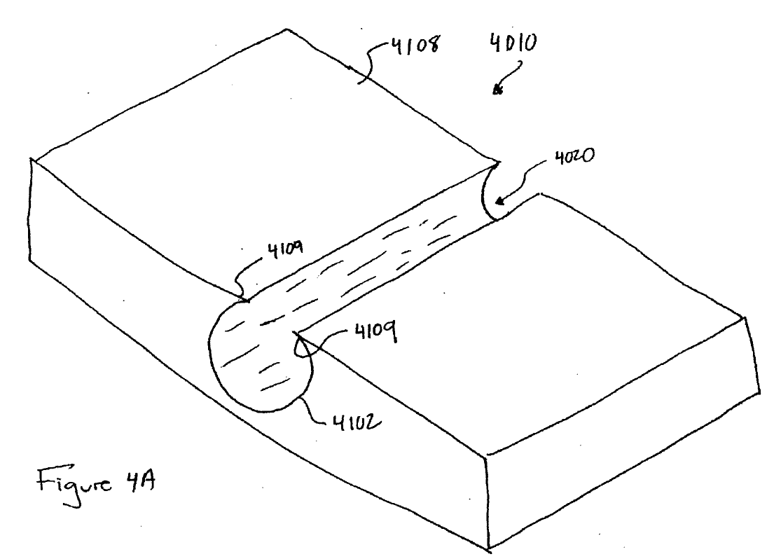

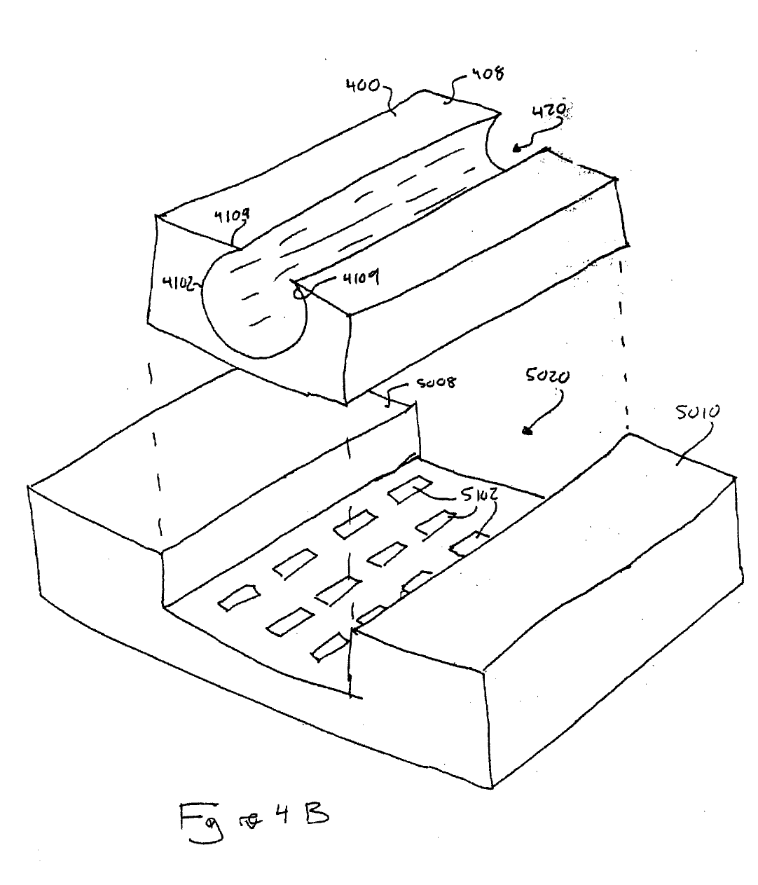

A second embodiment of a mass spectrometer probe according to the present invention will hereafter be described with reference to FIGS. 3-4B.

As shown in FIG. 3, the probe 300, which is generally tubular in shape, includes a top, sample presenting surface 308 and a rounded, oval-shaped underside 310. The sample presenting surface 308 provides a plurality of locations 307 onto which a mass spectrometry sample may be provided. Of course, the locations 307 may be in the form of microwells, e.g., depressions formed in the sample presenting surface 308. Moreover, one or more of the locations 307 may be circumscribed by a microstructure 306 such as a moat, which serves to facilitate maintaining a sample at a particular location 307. Further, the locations 307 and/or microstructures 306 may be arranged in a Cartesian coordinate system, thereby enabling a technician to track the location of particular samples on the sample presenting surface 308. The curved underside 310 is sized such that the probe 300 can slide into a probe receiving section 420, 4020 of a carrier plate 400 or a repeller plate 4010, while maintaining an engagement between the probe 300 and the carrier plate 400 or the repeller plate 4010, as hereafter described with respect to FIGS. 4A (repeller plate 4010) and 4B (carrier plate 400).

In a manner similar to the probe 300, the repeller plate 4010 includes a topside 4108 and an underside 4110. As shown, a probe receiving section 4020 is formed in the topside 4108 of the repeller plate 4010. The probe receiving section 4020 includes a curved, oval-shaped wall 4102 that defines two overhangs 4109, which jointly serve as a probe interface. The curved wall 4102 and the overhangs 4109 are sized such that the probe 300 may slide into the repeller plate 4010 in a direction parallel to a longitudinal axis LA′ of the probe 300 (shown in FIG. 3). When the probe 300 slides into the probe receiving section 4020, the overhangs 4109 will cover the probe 300 to such a degree that the probe 300 will be unable to be removed from the repeller plate 4010 in any direction other than parallel to the longitudinal axis LA′ thereof. Moreover, when the probe 300 is positioned in the probe receiving section 4020 of the repeller plate 4010, the top, sample presenting surface 308 of the probe 300 will be substantially coplanar with the topside 4108 of the repeller plate 4010.

As shown in FIG. 4B, the carrier plate 400 interacts with the probe 300 in the same manner as the repeller plate 4010. In other words, the carrier plate 400 also includes a probe receiving section 420 that is defined by a curved, oval-shaped wall 4102 and two overhangs 4109, which jointly serve as a probe interface. Moreover, when the probe 300 is positioned in the probe receiving section 420, the top, sample presenting surface 308 of the probe and a topside 408 of the carrier plate 400 will be substantially coplanar. In turn, the carrier plate 400 is sized to be received in a carrier plate receiving section 5020 of a repeller plate 5010. When the carrier plate 400 is received in the carrier plate receiving section 5020 of the repeller plate 5010, the topside 408 of the carrier plate 400 will not only be substantially coplanar with the top, sample presenting surface 308 of the probe 300 but also a topside 5008 of the repeller plate 5010. To maintain the carrier plate 400 in the carrier plate receiving section 5020 of the repeller plate 5010, numerous engagement means could be employed; magnets 5102 are one example of such engagement means.

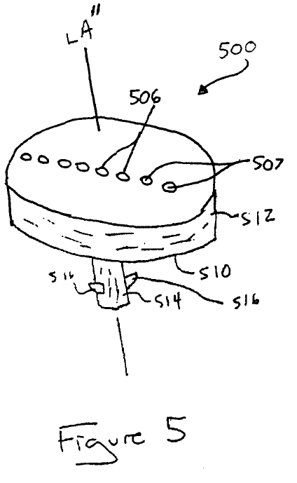

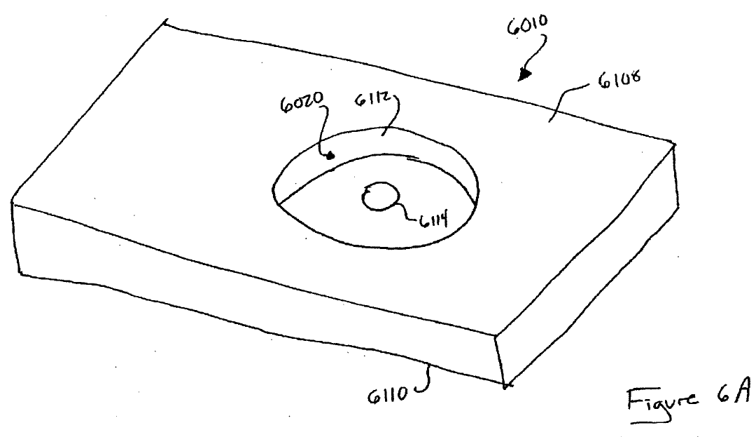

A third embodiment of a mass spectrometer probe according to the present invention will hereafter be described with reference to FIGS. 5-6B.

As shown in FIG. 5, the probe 500, which is disk-shaped, includes a top, sample presenting surface 508, an underside 510, a circular sidewall 512, and a post 514 from which spring-actuated buttons 516 project. The sample presenting surface 508 provides a plurality of locations 507 onto which a mass spectrometry sample may be provided. Of course, the locations 507 may be in the form of microwells, e.g., depressions formed in the sample presenting surface 508. Moreover, one or more of the locations 507 may be circumscribed by a microstructure 506 such as a moat, which serves to facilitate maintaining a sample at a particular location 507. Further, the locations 507 and/or microstructures 506 may be arranged in a Cartesian coordinate system, thereby enabling a technician to track the location of particular samples on the sample presenting surface 508.

The circular sidewall 512 is sized such that the probe 500 can slide into a probe receiving section 620, 6020 of a carrier plate 600 or a repeller plate 6010, while maintaining an engagement between the probe 500 and the carrier plate 600 or the repeller plate 6010, as hereafter described with respect to FIGS. 6A (repeller plate 6010) and 6B (carrier plate 600).

In a manner similar to the probe 500, the repeller plate 6010 includes a topside 6108 and an underside 6110. As shown, a probe receiving section 6020 is formed in the topside 6108 of the repeller plate 6010. The probe receiving section 6020 includes a circular sidewall 6102 that is configured to circumscribe the circular sidewall 512 of the probe 500 in a concentric fashion. The circular wall 6102 is sized such that the probe 500 may slide into the repeller plate 6010 in a direction parallel to a longitudinal axis LA″ of the probe 500 (shown in FIG. 5). When the probe 500 slides into the probe receiving section 6020, the post 514 will align with a hole 6114 in the bottom of the probe receiving section 6020 that serves as a probe interface. Moreover, as the post 514 is journalled through the hole 6114, the spring-actuated buttons 516 will be inwardly depressed into the post 514. When the spring-actuated buttons 516 clear the underside 6110 of the repeller plate 6010, the buttons 516 will outwardly spring onto the underside 6110, thereby immobilizing the probe 500 with respect to the repeller plate 6010. Moreover, when the probe 500 is positioned in the probe receiving section 6020 of the repeller plate 6010, the top, sample presenting surface 508 of the probe 500 will be substantially coplanar with the topside 6108 of the repeller plate 6010.

As shown in FIG. 6B, the carrier plate 600 interacts with the probe 500 in the same manner as the repeller plate 6010. In other words, the carrier plate 600 also includes a probe receiving section 620 that is defined by a curved wall 6102 and a hole 6114 that serves as a probe interface. Moreover, when the probe 500 is positioned in the probe receiving section 620, the top, sample presenting surface 508 of the probe 500 and a topside 608 of the carrier plate 600 will be substantially coplanar. In turn, the carrier plate 600 is sized to be received in a carrier plate receiving section 7020 of a repeller plate 7010, which also includes a hole 7114. The hole 7114 in the repeller plate 7010 is configured at least to receive the post 514 of the probe 500 and may, like the underside 6110 of the repeller plate 6010 be configured to engage the spring-actuated buttons 516. When the carrier plate 600 is received in the carrier plate receiving section 7020 of the repeller plate 7010, the topside 608 of the carrier plate 600 will not only be substantially coplanar with the top, sample presenting surface 508 of the probe 500 but also a topside 7008 of the repeller plate 7010. To maintain the carrier plate 600 in the carrier plate receiving section 7020 of the repeller plate 7010, numerous engagement means may be employed; magnets 7102 are one example of such engagement means.

In the foregoing embodiments, as a result of the top, sample presenting surface of the probe being substantially coplanar with the topside of the repeller plate (and the topside of the carrier plate if one is provided), the consistency of the electromagnetic field around the combination of the conductive probe and the repeller plate is substantially maintained.

In addition, it should be readily recognized that some technicians may opt to use the repeller plate 7010 shown in FIG. 6B, as it may be sized to receive not only the carrier plate 600 shown in FIG. 6B but also the carrier plates 200, 400 shown in FIGS. 2B and 4B. In other words, costs may be reduced by employing one repeller plate 7010 and using it conjunction with any of the carrier plates 200, 400, 600 described herein.

### Material for Mass Spectrometer Probe

To enable the mass spectrometer probe to be mass-produced at low cost, plastic was considered, especially as most plastics are hydrophobic. However, it was also recognized that plastics typically experience outgassing in mass spectrometers and are typically nonconductive, both of which can negatively affect mass spectrometry in constant energy ion laser desorption/ionization TOF mass spectrometers. As a result, the present invention aimed to create a probe, which is conductive and which optionally includes transparent portions, out of a polymer that exhibits low outgassing, that affords a high amount of abstractable hydrogen atoms, that exhibits both chemical and mechanical stability, and that can be easily molded into a probe of the types previously described in FIGS. 1, 3, and 5.

The create such a probe, an appropriate amount (1-50% in weight, e.g., 30% in weight) of conductive solute material is added to a nonconductive solvent polymer (e.g., polymethylpentene, polybutyltherephtalate, etc.) that in the absence of such a solute may otherwise be transparent. Although the conductive material may be either non-metallic (e.g., graphite, metal oxides such as antimony-tin oxide, indium-tin oxide, etc.) or metallic (e.g., antimony, aluminum, etc.), non-metallic materials may be preferable. The mixture is then molded (e.g., injection molding, over-molding, etc.) into a mass spectrometer probe, possibly with a microstructure imprint of an array and/or a moat sized for sample containment. The molded probe is then cooled and removed from the molding apparatus. By doping the polymer with the conductive material, the resultant probe is conductive. The conductive nature of the doped-polymer probe is not to be confused with conductive polymers (e.g., polypyrrole). Moreover, in certain embodiments, the probe may be substantially free (e.g., comprising less than about 1% of a metal) or completely free of metal.

Table 1 compares various physical properties of six nonconductive plastic polymers that were identified as potential polymer solvents for use in creating a mass spectrometer probe.

TABLE 1

| | | | | | Attachment with | Abstractable |
|---|---|---|---|---|---|---|
| | Moldability | Outgassing | Hydrophobicity | Morphology | benzophenone? | hydrogen? |
| Polyacrylate | Easy | Not Low | Average | Amorphous | Yes | High |
| (Plexiglas) | | | | | | |
| Polycarbonate | Easy | Not Low | Average | Amorphous | Yes | Moderate |
| (Lexan) | | | | | | |
| Polyetherimide | Easy | Not Low | Average | Amorphous | Yes | Low |
| Polybutyltherephtalate | Easy | Low | Average | Semicrystalline | Yes | Moderate |
| Polymethylpentene | Easy | Low | High | Semicrystalline | Yes | High |

With respect to Table 1, a polymer is generally determined to have “low” outgassing if its pump down time to 5.5 mV in a Ciphergen PCS 4000 mass spectrometer is less than about 150 seconds and “not low” outgassing if its pump down time is greater than 150 seconds. Similarly, a polymer is generally understood to have “low” hydrophobicity when the contact angle of deionized water is less than 60°, “average” hydrophobicity when the contact angle of deionized water is between 60° and 85°, and “high” hydrophobicity when the contact angle of deionized water is greater than 85° (typically up to about 120°).

As can be seen in Table 1, both polymethylpentene and polybutyltherephtalate exhibit: (a) easy moldability; (b) low outgassing; (c) at least an average hydrophobicity; (d) a semicrystalline morphology; (e) ability to bond with benzophenone (i.e., a chemistry used to cross-link polymers and couple them to the surface of a mass spectrometer probe); and (f) at least a moderate amount of abstractable hydrogen atoms. As a result of these positive attributes, polymethylpentene and polybutyltherephtalate were further tested for chemical and mechanical stability when exposed to various solvents. A polymer is considered to have “chemical stability” when it does not deteriorate when exposed to typical solvents such as organic solvents (e.g., methanol, ethanol, hexane, chloroform, etc.). Similarly, a polymer is considered to have “mechanical stability” when it does not scar, break-apart, or become damaged during insertion into, and removal from, a mass spectrometer. Both polymethylpentene and polybutyltherephtalate were determined to have mechanical stability; the results of their chemical stability are shown in Table 2.

TABLE 2

| Solvents | Polybutyltherephtalate | Polymethylpentene |
|---|---|---|
| Dimethyl Sulfoxide | No Change | No Change |
| Acetonitrile | No Change | No Change |
| Ethanol | No Change | No Change |
| Acetone | No Change | No Change |
| Chloroform | Slight Swelling | Slightly Dissolved |
| | | and Bent |
| Tris/HCl pH 8.5/1 M NaCl | No Change | No Change |
| 5% NH₄Cl | No Change | No Change |
| 5 wt % TFA | No Change | No Change |
| 0.2 M acetic acid | No Change | No Change |

As a result of the similar chemical and mechanical stability of both polymethylpentene and polybutyltherephtalate when exposed to the solvents in Table 2, probes were fashioned from polymethylpentene doped with carbon black (i.e., graphite) and polybutyltherephtalate doped with carbon black. Each of these carbon black doped probes was then compared against similar non-doped probes for the properties shown in Table 3.

TABLE 3

| | | Containment of 1 μl | Containment of | | Pump |
|---|---|---|---|---|---|
| | Contact Angle | of 50% | 1 μl 50% | | down |
| | of deionized | acetonitrile | acetonitrile | | time to |
| | water | without a moat? | with a moat? | Conductivity | 5.5 mV |
| Polybutyltherephtalate | 70 | No | Yes | No | 345 sec |
| Polymethylpentene | 106 | Yes | Yes | No | 60 sec |
| Polybutyltherephtalate | 60 | No | Yes | Yes | 80 sec |
| doped with carbon | | | | | |
| black | | | | | |
| Polymethylpentene | 60 | No | Yes | Yes | 60 sec |
| doped with carbon | | | | | |
| black | | | | | |

The hydrophobicity of non-carbon black doped polymethylpentene is such that the surface of a probe formed of polymethylpentene is capable of containing 1-2 μl of an energy absorbing molecule (“EAM”), even without a moat. Further, regardless of the polymer and regardless of carbon black doping, it is clear that a moat enhances the ability of the probe to contain a sample.

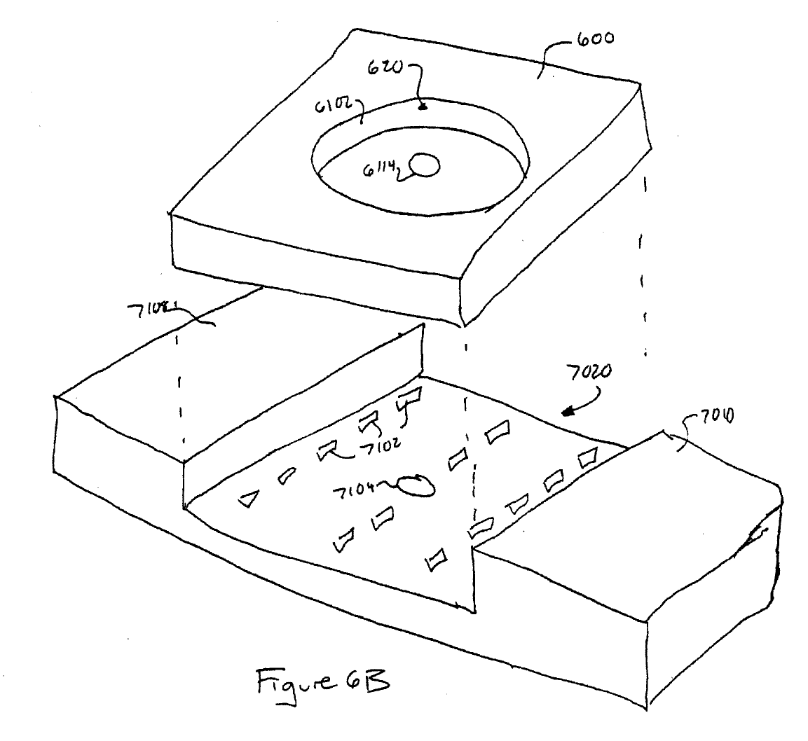

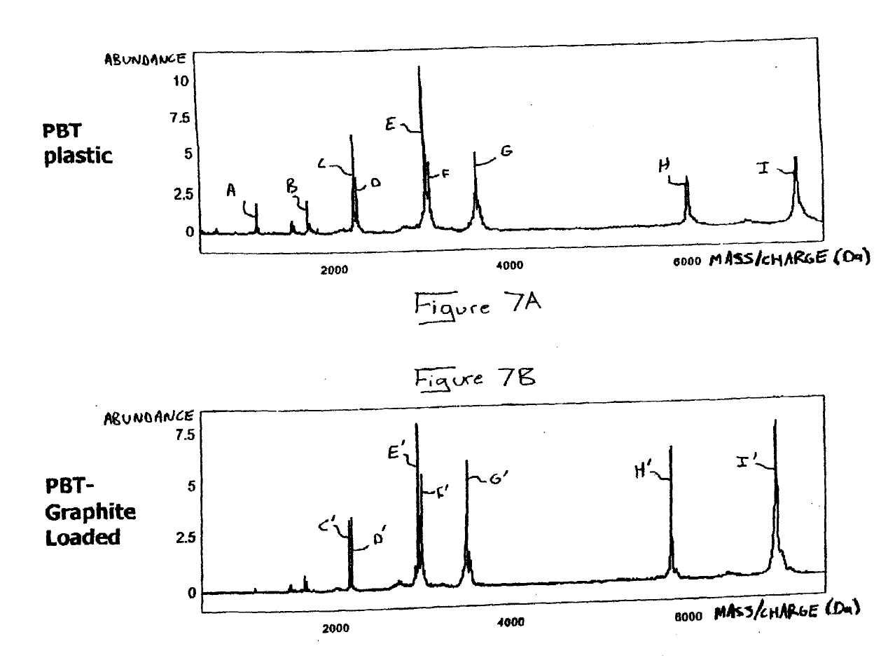

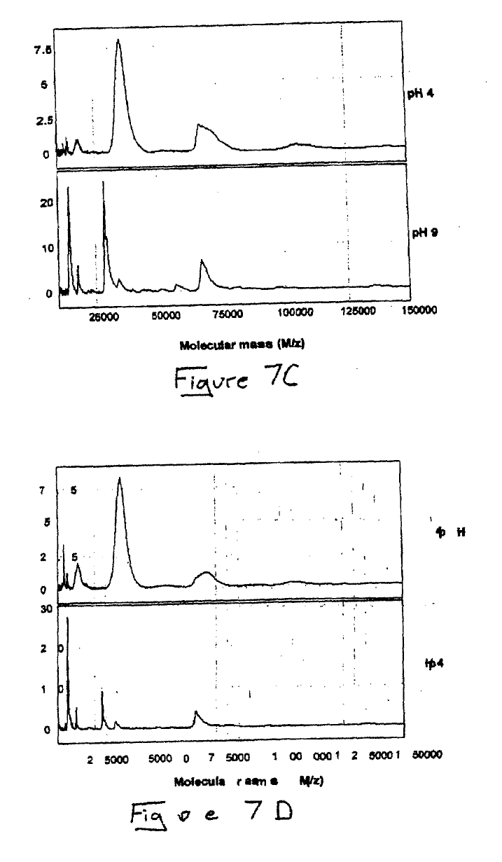

In light of the conductivity of both polymethylpentene and polybutyltherephtalate when doped with carbon black, mass spectrometry of a peptide sample was performed using the probes formed of: (a) polybutyltherephtalate both with and without carbon black doping; and (b) polymethylpentene both with and without carbon black doping. The result of the mass spectrometry of both of the polybutyltherephtalate probes are shown in FIGS. 7A and FIG. 7B. More specifically, FIG. 7A shows the mass spectrometry output of the peptide sample when positioned in a constant energy ion laser desorption/ionization TOF mass spectrometer on the polybutyltherephtalate probe lacking carbon black doping. Similarly, FIG. 7B shows the mass spectrometry output of the same peptide sample positioned in the constant energy ion laser desorption/ionization TOF mass spectrometer on the polybutyltherephtalate probe doped with carbon black.

In FIG. 7A, the resultant mass spectrometry identifies nine peaks A-I. In contrast, the mass spectrometry results in FIG. 7B identifies seven peaks C′-I′, which correspond to peaks C-I in FIG. 7A. As can be seen by comparing the mass spectrometry outputs of FIGS. 7A and 7B, the first two peaks A, B in FIG. 7A are essentially eliminated in FIG. 7B, thereby indicating that peaks are indicative of artifacts of the nonconductive probe rather than the peptide sample. In addition, both the magnitude and the location (i.e., mass-to-charge position) of peaks C-I are adjusted in FIG. 7B toward respective levels and positions that are obtained when using a Ciphergen Q10 ProteinChip® array probe. In other words, by doping the polybutyltherephtalate probe with graphite to enable the probe to be conductive, probe artifact peaks A and B are eliminated and peaks C-I are more accurately reflected in peaks C′-I′.

Similar results were obtained using the polymethylpentene probes (with and without carbon black doping). Accordingly, a duplicative discussion of the mass spectrometry results will be omitted.

To illuminate the accuracy of probes formed of a nonconductive polymer doped with conductive material, two pH comparisons were performed between a carbon black doped polybutyltherephtalate probe and a standard Q10 ProteinChip® array probe. Specifically, FIGS. 7C and 7D respectively show mass spectrometry results of human serum at pH 4 and pH 9 on a carbon black doped polybutyltherephtalate probe and on a standard Q10 ProteinChip® array probe. As can be seen, for both pH levels, both the carbon black doped polybutyltherephtalate probe and the standard Q10 ProteinChip® array probe identify essentially the same peaks at substantially the same molecular mass-to-charge ratio positions.

### Material for Hydrogel Coating Layer on Mass Spectrometer Probe

In certain embodiments of this invention the surface of a laser desorption/ionization probe is enhanced to selectively bind analytes from a sample. Such probes are referred to as SELDI (Surface-Enhanced Laser Desorption/Ionization) probes. Probe surfaces are enhanced by attaching analyte binding moieties to them. Analyte binding moieties include both chromatographic and biospecific adsorbent materials. Chromatographic materials include, for example, hydrophobic moieties, hydrophilic moieties, anion exchange materials, cation exchange materials, immobilized metal chelates and dyes. Biospecific adsorbent materials include, for example, antibodies and binding portions thereof, receptors and nucleic acids (DNA and RNA). Such analyte binding moieties will selectively bind analytes from a sample to which they are attracted. Unbound materials can be washed away from the surface. This allows for on-chip fractionation of a sample. The analyte binding moieties can be attached to the surface of the probe by chemisorption or physisorption. In preferred embodiments, the analyte binding moieties are provided in the form of a hydrogel. Hydrogels are preferred because their volume allows them to bind increased amounts of an analyte from a sample. In one embodiment, the hydrogel is formed using a photoreactive chemistry, such as benzophenone, to cross-link linear polymers with each other and, optionally, to the surface of the probe.

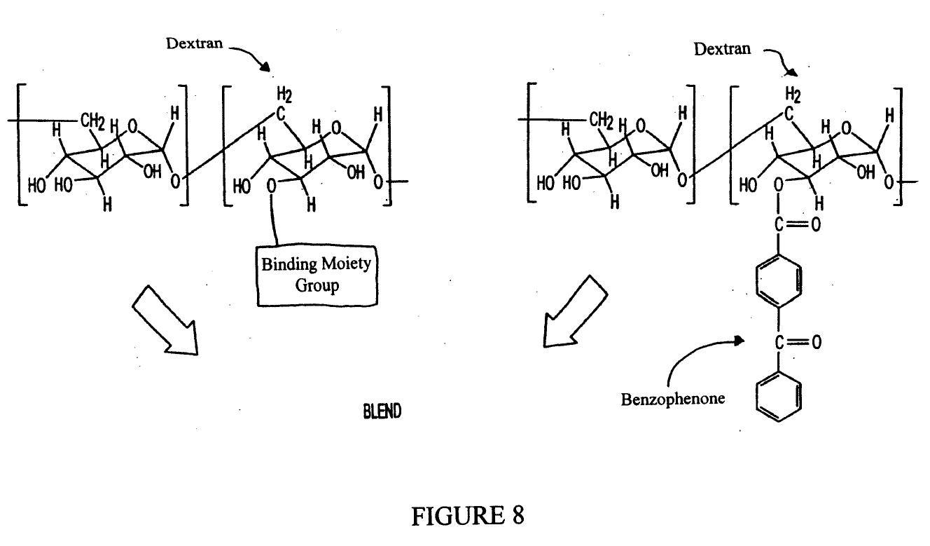

Benzophenone is attractive for this use because it can couple to abstractable hydrogen atoms on the surface of the probe and because it is compatible with most plastics when creating an activated surface. Examples of both blended polymers and copolymers comprising analyte binding moieties and formed through the use of benzophenone chemistry are described in U.S. Patent Application Publication Nos. 2004-0124149 and 2005-0059086. Because of their versatility, blended polymers are particularly attractive. Briefly, in the case of blended polymers a first polymer, such as dextran, is derivatized with benzophenone groups. A second polymer, also, for example, dextran, is derivatized with analyte binding moiety group (e.g., hydrophilic groups, hydrophobic groups, metal chelates (e.g., IMAC), anion exchange groups, cation exchange groups, dyes or chemically reactive groups). The two polymers are mixed, placed, or coated (optionally in the form of a predetermined pattern) on the surface of the probe and exposed to light. This causes the photoreactive benzophenone groups to react with abstractable hydrogens in both polymers and the polymeric material in the probe. This results in a cross-linked hydrophilic polymer attached to the surface of the probe. A layered polymer also may be applied to the probe. An example of such a blended copolymer hydrogel, which is shown in FIG. 8, is formed of a mixture of: (a) dextran derivatized with benzophenone; and (b) dextran derivatized with a binding moiety group (e.g., DEAE).

Other polymers that may be used to create an activated surface include ultraviolet (“UV”) sensitive benzophenone-Q polymer (quarternary ammonium), benzophenone-DEAE dextran, benzophenone-CM polymer (carboxymethylate), benzophenone-immobilized metal interaction chromatography (“IMAC”) polymer, benzophenone-H₅₀ polymer, polysaccharides (e.g., dextran), and synthetic polymers (e.g., acrylic soluble copolymers). Moreover, certain of these polymers may be used based on certain desired properties (e.g., benzophenone-dextran or DEAE-dextran could be used to obtain an anion exchange surface).

### Probe Fabrication Methodology

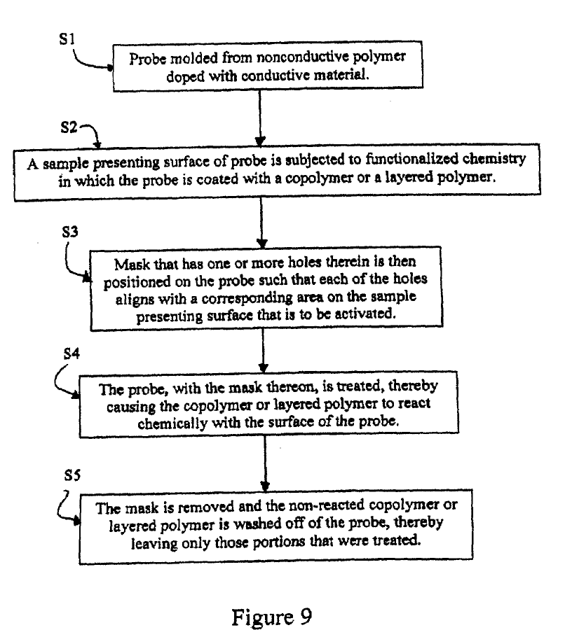

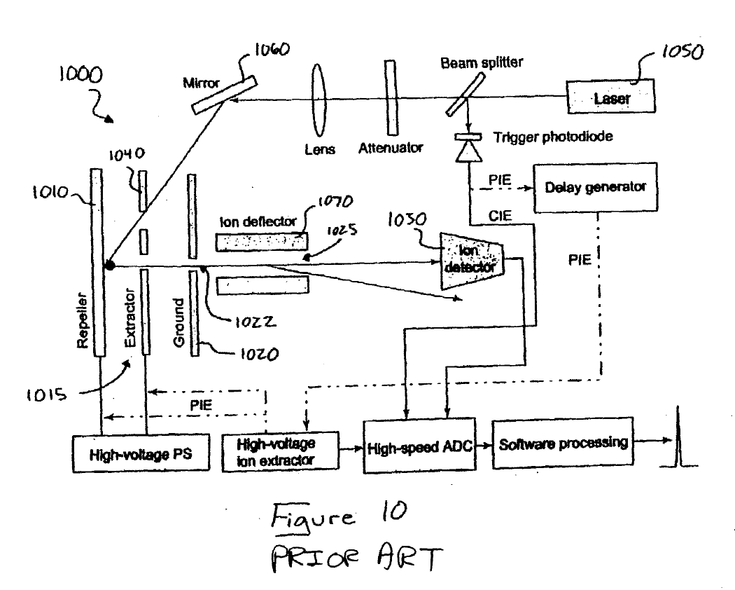

As shown in FIG. 9, in step S1, the probe is initially molded from a polymer (e.g., polymethylpentene) doped with a conductive material (e.g., carbon black), as previously described. Subsequently, in step S2, the sample presenting surface (or portions thereof) of the probe is subjected to functionalized chemistry to create activated areas to which samples may bind. Each of the activated areas may be in the form of a microstructure (e.g., a well) and/or a location that may be surrounded by a microstructure such as a moat. To create the activated areas, the entire probe is coated (e.g., drip coating, dip coating, spray coating, spin coating, projection coating, printing, etc.) with a copolymer (e.g., a blended copolymer of dextran derivatized with benzophenone and dextran derivatized with a binding moiety group), a layered polymer, or a combination of a copolymer and a layered polymer. After the probe is fully coated, a mask that has one or more holes therein is positioned on the probe such that each of the holes aligns with a corresponding area on the sample presenting surface that is to be activated, as shown in step S3. Next, in step S4, the probe, with the mask thereon is treated, thereby causing the copolymer, the layered polymer, or the copolymer and layered polymer combination to react chemically with the surface of the probe. For example, the copolymer, layered polymer, or the copolymer and layered polymer combination could be treated using photo-activated chemistry such as being exposed to UV light for 5-15 minutes. Finally, in step S5, after the treating (e.g., the UV irradiation) is complete, the mask is removed and the non-reacted copolymer, layered polymer, or the copolymer and layered polymer combination is washed off of the probe, thereby leaving only those portions that were treated.

Various advantages are afforded by the conductive probes of the present invention. For example, the mass spectrometer probes may be at least partially transparent, thereby enabling a technician to visualize a sample on the probe. More specifically, the probes may have one or more transparent locations on the sample presenting surface onto which the analyte is positioned for analysis. To create the transparent locations, after the probe is molded (in Step S1), small holes may be drilled through the probe. Subsequently, the holes may be filled with a transparent polymer (which may be the same nonconductive polymer that was used to mold the probe) that is not doped with conductive material. The probe may then be re-molded. Although, the overall conductivity of the probe may be slightly degraded, the degradation should be to such a limited degree that it will have a negligible affect on the resultant mass spectrometry. As a result, the probe will have transparent channels therethrough, thereby enabling a technician to view (e.g., by light microscopy, fluorescence, chemiluminence, etc.) samples positioned on locations on the sample presenting surface that are aligned with the channels.

In other embodiments, the holes may be formed during probe formation. For example, before the probe is molded in Step S1, micropipettes (or other similar structure) could be positioned in the mold in locations that are to be transparent. Accordingly, after the polymer is added, the polymer will fill all portions of the mold except for those portions that are already occupied by the micropipettes. As a result, after the polymer is molded, the micropipettes could be removed, thereby yielding holes through the probe.

It should be readily recognized that the same drilling and polymer filling steps may used to add transparent locations to conventional metal (e.g., aluminum) probes. As a result of such transparent locations in conventional probes, the conventional probes could be used in other analysis protocols such as light microscopy, fluorescence, chemiluminence, etc.

By way of another example, the conductivity of the probes maintains the consistency of the electromagnetic field generated in the mass spectrometer, thereby ensuring the accuracy of the mass spectrometry.

By way of another example, the probes exhibit low outgassing, thereby preventing impurities from negatively affecting the mass spectrometry.

By way of still another example, the probes may be mass-produced at low cost. Moreover, the probes may be readily molded into any desired shape, i.e., the probes may be molded into shapes other than rectangular, tubular, and disk-shaped.

By way of yet another example, samples may be positioned directly on the probe, which, in turn, can be automatically received by the probe interface of the mass spectrometer, thereby significantly reducing production costs and enhancing reproducibility.

Although the aforementioned describes embodiments of the invention, the invention is not so restricted. It will be apparent to those skilled in the art that various modifications and variations can be made to the disclosed embodiments of the present invention without departing from the scope or spirit of the invention.

For instance, the polymer probe may be formed of nonconductive polymer that is coated with conductive suspension (e.g., graphite suspension).

By way of another example, the probe may be formed using an over-molding technique by which zones of conductivity and zones of transparency may be established. More specifically, the probe may be formed of two or more polymers, e.g., a first polymer layer could have conductive mass spectrometer properties and a second layer could be better configured to bind samples (e.g., protein) on a surface thereof by way of a specific function. The surface of the second layer could be functionalized, e.g., for porosity, transparency, ion exchange, hydrophobicity interaction, mix-mode interaction, IMAC, affinity for a particular target sample (e.g., a protein or family of proteins), reactivity for the rapid immobilization of a particular target sample, specific affinity biologicals (e.g., antibodies, lectins, receptors, and nucleic acids), small affinity ligands (e.g., dyes, peptides, oligonucleotides, and sugars), etc. In this embodiment, the first layer would be molded (e.g., injection molding, over-molding, etc.) and then the second layer would be molded onto the first layer (e.g., injection molding, over-molding, etc.). The subsequent steps for creating the probe may be substantially the same as steps S2-S5.

Accordingly, these other conductive mass spectrometer probes, mass spectrometers using such probes, methods of probe fabrication, and methods of sample analysis using such mass spectrometer probes are fully within the scope of the claimed invention. Therefore, it should be understood that the devices and methods described herein are illustrative only and are not limiting upon the scope of the invention, which is indicated by the following claims.

What is claimed is:

1. A method of sample analysis comprising:
applying a sample comprising an analyte to a sample presenting surface of a mass spectrometer probe, wherein the mass spectrometer probe comprises a polymer doped with a conductive material;
engaging the probe with a probe interface of a mass spectrometer that generates ions through a desorption/ionization process, wherein the mass spectrometer is configured for parallel ion extraction;
desorbing and ionizing the analyte from the sample presenting surface with energy from an energy source; and
detecting the desorbed and ionized analyte.

2. The method of claim 1, wherein the polymer is selected from the group consisting of polymethylpentene, polybutyltherephtalate, and polyacrylates.

3. The method of claim 1, wherein the conductive material is selected from the group consisting of graphite, metal, and metal oxide.

4. The method of claim 2, wherein the conductive material is selected from the group consisting of graphite, metal, and metal oxide.

5. The method of claim 1, wherein the polymer comprises polymethylpentene and the conductive material is graphite.

6. The method of claim 1, wherein the probe further comprises analyte binding moieties bonded to the sample presenting surface through photo-activated chemistry.

7. The method of claim 1, wherein the energy source is a laser.

8. The method of claim 1, wherein the sample presenting surface has one or more locations onto which the analyte is positioned for analysis.

9. The method of claim 8, wherein the one or more locations are transparent to visible light.

10. The method of claim 1, wherein the probe is made by two or more layers of plastic with at least one different predetermined property selected from the group consisting of transparency, porosity, hydrophobicity, and ability to react with a hydrophilic polymer through photo-activated chemistry.

11. The method of claim 1, wherein the probe comprises at least one microstructure.

12. The method of claim 1, wherein the probe further comprises a hydrogel attached to the sample presenting surface through a photo-activated chemistry.

13. The method of claim 1, wherein the conductive material is non-metallic, and wherein the probe is substantially free of metal.

14. The method of claim 13, wherein the non-metallic conductive material is selected from the group consisting of graphite, antimony-tin oxide, and indium-tin oxide.

15. The method of claim 1, wherein the probe is substantially rectangular in shape.

16. The method of claim 1, wherein the probe is substantially tubular in shape.

17. The method of claim 1, wherein the probe is substantially disk-shaped.

18. A mass spectrometer probe comprising a substrate that comprises a polymer doped with a conductive material, wherein the probe comprises an engagement mechanism that is configured to engage a probe interface of a mass spectrometer that generates ions through a desorption/ionization process, and wherein the mass spectrometer is configured for parallel ion extraction.

19. The mass spectrometer probe of claim 18, wherein the polymer is selected from the group consisting of polymethylpentene, polybutyltherephtalate, and polyacrylates.

20. The mass spectrometer probe of claim 18, wherein the conductive material is selected from the group consisting of graphite, metal, and metal oxide.

21. The mass spectrometer probe of claim 19, wherein the conductive material is selected from the group consisting of graphite, metal, and metal oxide.

22. The mass spectrometer probe of claim 18, wherein the polymer comprises polymethylpentene and the conductive material is graphite.

23. The mass spectrometer probe of claim 18, wherein the probe further comprises analyte binding moieties bonded to a sample presenting surface through photo-activated chemistry.

24. The mass spectrometer probe of claim 18, wherein the sample presenting surface has one or more locations that are configured to receive an analyte for analysis.

25. The mass spectrometer probe of claim 24, wherein the one or more locations are transparent to visible light.

26. The mass spectrometer probe of claim 18, wherein the probe is made by two or more layers of plastic with at least one different predetermined property selected from the group consisting of transparency, porosity, hydrophobicity, and ability to react with a hydrophilic polymer through photo-activated chemistry.

27. The mass spectrometer probe of claim 18, wherein the probe comprises at least one microstructure.

28. The mass spectrometer probe of claim 18, wherein the probe comprises a hydrogel attached to the sample presenting surface through a photo-activated chemistry.

29. The mass spectrometer probe of claim 18, wherein the conductive material is non-metallic, and wherein the probe is substantially free of metal.

30. The mass spectrometer probe of claim 29, wherein the non-metallic conductive material is selected from the group consisting of graphite, antimony-tin oxide, and indium-tin oxide.

31. The mass spectrometer probe of claim 18, wherein the probe is substantially rectangular in shape.

32. The mass spectrometer probe of claim 18, wherein the probe is substantially tubular in shape.

33. The mass spectrometer probe of claim 18, wherein the probe is substantially disk-shaped.

34. A time-of-flight mass spectrometer comprising:
(a) an ion source comprising:
a probe interface and a probe engaged therewith, wherein the probe comprises:
a polymer that is doped with a conductive material; and
a sample presenting surface;
an energy source; and
an ion optic assembly;
(b) a mass analyzer comprising a sub-assembly defining a free flight path; and
(c) an ion detector;
wherein the ion optic assembly is configured to deliver desorbed/ionized analyte molecules in a parallel extraction configuration to the mass analyzer, and
wherein the ion detector is configured to detect ions passing through the free flight path.

35. The mass spectrometer of claim 34, wherein the polymer is selected from the group consisting of polymethylpentene, polybutyltherephtalate, and polyacrylates.

36. The mass spectrometer of claim 34, wherein the conductive material is selected from the group consisting of graphite, metal, and metal oxide.

37. The mass spectrometer of claim 35, wherein the conductive material is selected from the group consisting of graphite, metal, and metal oxide.

38. The mass spectrometer of claim 34, wherein the sub-assembly comprises a flight tube or an electric sector.

39. The mass spectrometer of claim 34, wherein the energy source is a laser.

40. The mass spectrometer of claim 34, wherein the probe comprises a hydrogel attached to the sample presenting surface through a photo-activated chemistry.

41. The mass spectrometer of claim 34, wherein the polymer comprises polymethylpentene and the conductive material is graphite.

42. The mass spectrometer of claim 34, wherein the probe further comprises analyte binding moieties bonded to the sample presenting surface through photo-activated chemistry.

43. The mass spectrometer of claim 34, wherein the sample presenting surface has one or more locations that are configured to receive an analyte for analysis.

44. The mass spectrometer of claim 43, wherein the one or more locations are transparent to visible light.

45. The mass spectrometer of claim 34, wherein the probe is made by two or more layers of plastic with at least one different predetermined property selected from the group consisting of transparency, porosity, hydrophobicity, and ability to react with a hydrophilic polymer through photo-activated chemistry.

46. The mass spectrometer of claim 34, wherein the probe comprises at least one microstructure.

47. The mass spectrometer of claim 34, wherein the conductive material is non-metallic, and wherein the probe is substantially free of metal.

48. The mass spectrometer of claim 47, wherein the non-metallic conductive material is selected from the group consisting of graphite, antimony-tin oxide, and indium-tin oxide.

49. The mass spectrometer of claim 34, wherein the probe is substantially rectangular in shape.

50. The mass spectrometer of claim 34, wherein the probe is substantially tubular in shape.

51. The mass spectrometer of claim 34, wherein the probe is substantially disk-shaped.

52. A method of forming a mass spectrometer probe that is configured to engage a probe interface of a mass spectrometer, which generates ions through a desorption/ionization process and which is configured for parallel ion extraction, the method comprising the steps of:
doping a nonconductive first polymer with a conductive material;
molding the doped first polymer into a probe that is configured to engage a probe interface of a mass spectrometer;
coating a surface of the probe with a second polymer comprising at least one photoreactive moiety;
covering the coated surface with a mask that exposes one or more areas on the surface;
treating the exposed areas such that the photoreactive moieties of the second polymer in the exposed areas bind to the surface of the probe, thereby forming a hydrogel;
removing the mask; and
removing the second polymer from the unexposed areas of the surface.

53. The method of claim 52, wherein the first polymer is selected from the group consisting of polymethylpentene, polybutyltherephtalate, and polyacrylates.

54. The method of claim 52, wherein the conductive material is selected from the group consisting of graphite, metal, and metal oxide.

55. The method of claim 53, wherein the conductive material is selected from the group consisting of graphite, metal, and metal oxide.

56. The method of claim 52, wherein the step of treating comprises irradiating the exposed areas with ultraviolet light.

57. The method of claim 52, wherein the coating step further comprises coating the surface with a third polymer comprising analyte binding moieties, and wherein the photoreactive moieties further bind the second polymer to the third polymer in the treating step.

58. The method of claim 52, wherein the second polymer is a co-polymer comprising:
monomers comprising the photoreactive moiety; and
monomers comprising analyte binding moieties.

59. The method of claim 52, further comprising the step of:
forming a microstruture around at least one of the area(s) of the sample presenting surface.

60. The method of claim 52, wherein the conductive material is non-metallic, and wherein the probe is substantially free of metal.

61. The method of claim 60, wherein the non-metallic conductive material is selected from the group consisting of graphite, antimony-tin oxide, and indium-tin oxide.
